(19) United States
(12) Patent Application Publication
(10) Pub. No.: US 2017/0277860 A1
(43) Pub. Date: Sep. 28, 2017

(54) Message Reminding Method and Message Reminding Device

(71) Applicant: Beijing Choice Electronic Technology Co., Ltd., Beijing (CN)

(72) Inventor: Shuhai Liu, Beijing (CN)

(73) Assignee: Beijing Choice Electronic Technology Co., Ltd., Beijing (CN)

(21) Appl. No.: 15/531,858

(22) PCT Filed: Nov. 30, 2015
(86) PCT No.: PCT/CN2015/095937

§ 371 Date: May 31, 2017

(30) Foreign Application Priority Data
Dec. 1, 2014 (CN) 201410711202.7

(51) Int. Cl. G06F 19/00; G06F 9/44; H04W 4/00; G06F 3/01

(52) U.S. Cl. CPC G06F 19/3456; G06F 3/01; G06F 9/44; H04W 4/00

(57) ABSTRACT

Disclosed is a message reminding method and device. The method includes the following steps: (1) receiving N reminder messages; (2) detecting current time and determining whether the P-th reminder time T_{P} is reached; (3) sending the P-th reminder content information while detecting a response message within a first predetermined sending time: if the response message is received within the first predetermined sending time, proceeding to step (4); otherwise, stopping sending the P-th reminder content information and modifying the P-th reminder time T_{P}; (4) determining whether the response message is a first or second response message: if the first response message, stopping sending the P-th reminder content information and cancelling the P-th reminder message; if the second response message, stopping sending the P-th reminder content information and changing the P-th reminder time T_{P} to a delayed time T′_{P}.

### FIELD OF THE INVENTION

The present invention relates to reminding method and device, and particularly relates to a message reminding method and a message reminding device.

### BACKGROUND OF THE INVENTION

With the improvement of living standard and the acceleration of life pace, people are more likely to suffer from chronic diseases, and often need medication for treatment. Particularly, some older people or busy people may often forget to take medicine or cannot take medicine on time. Especially, many users need to take more than one medicine, and for different medicines, medication time, medication quantity and duration of treatment may be different. Usually, a user needs to remember on his/her own, and therefore it is difficult to avoid a case where a medicine is taken by mistake or is missed, which will directly influence treatment and rehabilitation efficacy of the medicine, and even affect the user's health.

Currently, commercially available products having a medication reminder function include smart pillboxes, watches, etc. However, these products generally provide a single function only, i.e., a reminder function, do not yet support confirmation or delay of a medication reminder through a simple human-computer interaction, and lack more efficient and humanized treatment process, that is, these products provide no corresponding feedback no matter whether a user takes or does not take a medicine, has no supervisory function, and cannot comprehensively supervise the user to take a right medicine on time to ensure treatment effect.

### SUMMARY OF THE INVENTION

To solve the above problem, the present invention provides a message reminding method, which includes the following steps:

(1) receiving N reminder messages; wherein a P-th reminder message includes a P-th reminder time T_{P} and a P-th reminder content information, where N and P are natural numbers, and P≦N;

(2) detecting current time and determining whether the P-th reminder time T_{P} is reached, if yes, proceeding to step (3); otherwise, continuing to detect current time;

(3) sending the P-th reminder content information while detecting a response message within a first predetermined sending time:
if the response message is received within the first predetermined sending time, proceeding to step (4);
if no response message is received before the first predetermined sending time elapses, stopping sending the P-th reminder content information and modifying the P-th reminder time T_{P}, wherein one of modifying ways includes: no longer determining whether the current time reaches the P-th reminder time T_{P} before 24:00 on that day; and

(4): determining whether the response message is a first response message or a second response message: if it is the first response message, stopping sending the P-th reminder content information and cancelling the P-th reminder message; if it is the second response message, stopping sending the P-th reminder content information and changing the P-th reminder time T_{P} to a delayed time T′_{P}.

Step (2) further includes: continuing to detect current time if the P-th reminder time T_{P} is not reached and no second response message is detected; and changing the P-th reminder time T_{P} to the delayed time T′_{P} if the P-th reminder time T_{P} is not reached but the second response message is detected.

The method further includes receiving a Q-th reminder message, which includes a Q-th reminder time T_{Q} and a Q-th reminder content information, where Q is a natural number, Q≠P and T_{Q}>T_{P}; when T′_{P}=T_{Q}, step (3) further includes:
firstly, sending the P-th reminder content information while detecting a response message within the first predetermined sending time: if the response message is received within the first predetermined sending time, proceeding to step (4); if no response message is received before the first predetermined sending time elapses, stopping sending the P-th reminder content information and modifying the P-th reminder time T_{P} to increase the P-th reminder time T_{P} by 24 hours; and
then, sending the Q-th reminder content information while detecting a response message within the first predetermined sending time: if the response message is received within the first predetermined sending time, proceeding to step (4); if no response message is received before the first predetermined sending time elapses, stopping sending the Q-th reminder content information and modifying the Q-th reminder time T_{Q} to increase the Q-th reminder time T_{Q} by 24 hours.

The method further includes:
when the detected current time is 23:59, sending reminder content information of all to-be-reminded messages in order of reminder times of the to-be-reminded messages while detecting a response message within a second predetermined sending time;
determining whether or not the response message is the first or second response message: if it is the first or second response message, stopping sending the reminder content information of the to-be-reminded messages; and
cancelling all of the to-be-reminded messages, wherein for each of the to-be-reminded messages, whether its reminder time is reached is still to be determined.

Specifically, the method includes setting at least one of an indication light of a different color, a prompt voice and a vibration mode for each of the reminder messages; and sending the P-th reminder content information further includes: after receiving the P-th reminder content information, performing message reminding process in at least one of the following ways of: sending out a prompt voice corresponding to the P-th reminder message, lighting or blinking an indication light corresponding to the P-th reminder message, displaying a content corresponding to the P-th reminder message on a display screen, and vibrating a vibration motor in a vibration mode corresponding to the P-th reminder message.

Step (3) further includes: if no response message is received before the first predetermined sending time elapses, further transmitting out the P-th reminder time T_{P} and the P-th reminder content information, so that a receiver is able to remind the P-th reminder time T_{P} and the P-th reminder content information.

Specifically, the transmission is performed through wireless communication, and the receiver reminds the information sender of the P-th reminder time T_{P} and the P-th reminder content information.

Specifically, the method is applied to an intelligent mobile terminal and/or a wearable device.

Specifically, the N reminder messages are N medication reminder messages wherein a P-th medication reminder message includes a P-th reminder time T_{P} indicating medication time, and a P-th reminder content information indicating medicine type or name.

The message reminding method of the present invention can not only remind a user of corresponding information on time, but also receive confirmation and feedback on the reminded information, and process the feedback accordingly. Thus, a human-computer interaction function is achieved, and management of the reminder messages is more efficient and humanized.

The present invention further provides a message reminding device, including:

a receiving module, configured to receive N reminder messages, wherein a P-th reminder message includes a P-th reminder time T_{P} and a P-th reminder content information, where N and P are natural numbers, and P≦N;

a time detection and determination module, configured to detect current time and determine whether the current time reaches the P-th reminder time T_{P};

an interaction module, configured to perform, after receiving the P-th reminder content information, message reminding process in at least one of the following ways of: sending out a prompt voice corresponding to the P-th reminder message, lighting or blinking an indication light corresponding to the P-th reminder message, displaying a content corresponding to the P-th reminder message on a display screen, and vibrating a vibration motor in a vibration mode corresponding to the P-th reminder message;

an information sending and response processing module, configured to send the P-th reminder content information to the interaction module while detecting a response message within a first predetermined sending time:
if the response message is received within the first predetermined sending time, determine whether the response message received by the information sending and response processing module is a first response message or a second response message: if it is the first response message, stop sending the P-th reminder content information and cancel the P-th reminder message; if it is the second response message, change the P-th reminder time T_{P} to a delayed time T′_{P};
if no response message is received before the first predetermined sending time elapses, stop sending the P-th reminder content information to the interaction module and modify the P-th reminder time T_{P}, wherein one of modifying ways includes: making the time detection and determination module no longer determine whether the current time reaches the P-th reminder time T_{P} before 24:00 on that day.

The time detection and determination module is further configured to: continue to detect current time if the P-th reminder time T_{P} is not reached and no second response message is detected, and change the P-th reminder time T_{P} to the delayed time T′_{P} if the P-th reminder time T_{P} is not reached but the second response message is detected,

The receiving module further receives a Q-th reminder message, which includes a Q-th reminder time T_{Q} and a Q-th reminder content information, where Q is a natural number, Q≠P and T_{Q}>T_{P}; and when T′_{P}=T_{Q}, the information sending and response processing module is sequentially configured to:
send the P-th reminder content information to the interaction module while detecting a response message: if the response message is received within the first predetermined sending time, determine whether the response message received by the information sending and response processing module is a first response message or a second response message: if it is the first response message, stop sending the P-th reminder content information and cancel the P-th reminder message; if it is the second response message, change the P-th reminder time T′_{P} to a delayed time T″_{P}; if no response message is received before the first predetermined sending time elapses, stop sending the P-th reminder content information to the interaction module and modify the P-th reminder time T_{P}, wherein one of modifying ways includes: making the time detection and determination module no longer determine whether the current time reaches the P-th reminder time T_{P} before 24:00 on that day; and
send the Q-th reminder content information to the interaction module while detecting a response message: if the response message is received within the first predetermined sending time, then determine whether the response message received by the information sending and response processing module is the first response message or the second response message: if it is the first response message, stop sending the Q-th reminder content information and cancel the Q-th reminder message; if it is the second response message, change the Q-th reminder time T_{Q} to a delayed time T′_{Q}; if no response message is received before the first predetermined sending time elapses, stop sending the Q-th reminder content information to the interaction module and modify the Q-th reminder time T_{Q}, wherein one of modifying ways includes: making the time detection and determination module no longer determine whether the current time reaches the Q-th reminder time T_{Q} before 24:00 on that day.

The information sending and response processing module is further configured to send reminder content information of all to-be-reminded messages in order of reminder times of the to-be-reminded messages while detecting a response message within a second predetermined sending time; and determine whether or not the response message is the first or second response message: if it is the first or second response message, stop sending the reminder content information of the to-be-reminded messages; and

the time detection and determination module is further configured to cancel all of the to-be-reminded messages when the detected current time is 23:59, wherein for each of the to-be-reminded messages, whether its reminder time is reached is still to be determined.

Specifically, the interaction module includes at least one of an indication light, a loudspeaker, a display screen, and a vibration motor, and accordingly sets at least one of an indication light of a different color, a prompt voice, a display content, and a vibration mode for each of the reminder messages.

The message reminding device further includes:

a communication device, configured to transmit out the P-th reminder time T_{P} and the P-th reminder content information if no response message is received before the first predetermined sending time elapses, so that a receiver is able to remind the P-th reminder time T_{P} and the P-th reminder content information.

Specifically, the transmission is performed through wireless communication, and the receiver reminds the information sender of the P-th reminder time T_{P} and the P-th reminder content information.

Specifically, the message reminding device is integrated in an intelligent mobile terminal and/or a wearable device.

Specifically, the N reminder messages are N medication reminder messages wherein a P-th medication reminder message includes a P-th reminder time T_{P} indicating medication time, and a P-th reminder content information indicating medicine type or name.

The message reminding device of the present invention has beneficial effects as follows. By integrating or combining the message reminding device with an intelligent mobile terminal and a wearable device by an application (APP), a user can set relevant parameters (e.g., reminder time, reminder content, etc.) in the APP freely, conveniently and flexibly, and the device can help the user to accurately finish reminders on time and quantity. Furthermore, after the reminder is sent out, the user can give a feedback on confirmation or delay of completion of the reminder according to his/her own situation, the system can proceed accordingly upon receipt of the feedback, thus a human-computer interaction function can be achieved, and management of the reminder messages is more efficient and humanized. By providing two or more intelligent terminals and transmitting the reminder information contents to the multiple terminals wirelessly, the role of multiple supervisions and reminders can be played, thus achieving the purpose of remote reminder, wardship and care.

### BRIEF DESCRIPTION OF THE DRAWINGS

Accompanying drawings, which constitute a part of the specification, are used for providing a further understanding of the present invention, and explaining the present invention together with the following specific implementations, rather than limiting the present invention. In the accompanying drawings:

FIG. 1 is a flowchart of a message reminding method in a first embodiment of the present invention;

FIG. 2 is a flowchart of a message reminding method in a second embodiment of the present invention; and

FIG. 3 is a schematic block diagram of a structure of a message reminding device according to the present invention.

### DETAILED DESCRIPTION OF THE EMBODIMENTS

Specific implementations of the present invention will be described in detail below in conjunction with the accompanying drawings. It should be understood that the specific implementations described herein are merely used for describing and explaining the present invention rather than limiting the present invention.

To make those skilled in the art better understand the technical solutions of the present invention, a message reminding method and a message reminding device provided in the present invention will be described in detail in conjunction with the accompanying drawings.

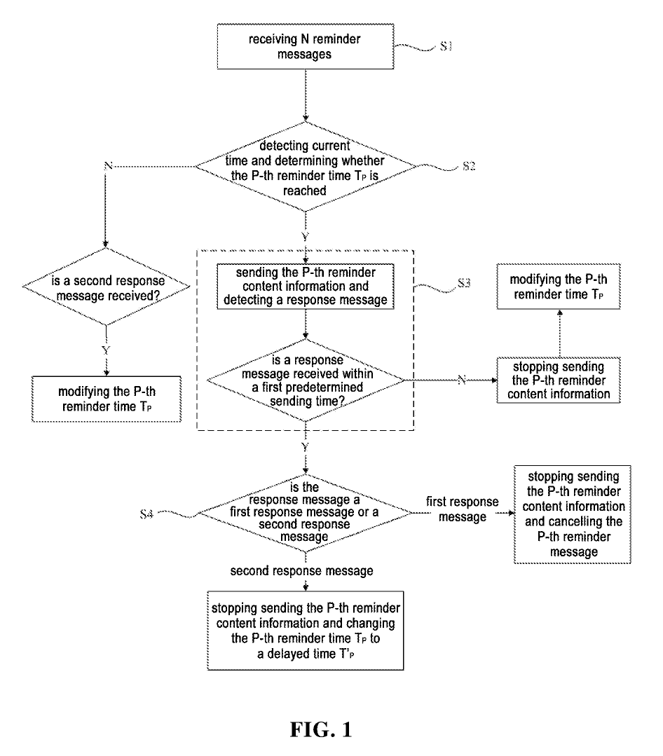

FIG. 1 is a flowchart of a message reminding method in a first embodiment of the present invention. The method includes the following steps:

S1: receiving N reminder messages; wherein a P-th reminder message includes a P-th reminder time T_{P} and a P-th reminder content information, where N and P are natural numbers, and P≦N;

S2: detecting current time and determining whether the P-th reminder time T_{P} is reached: if yes, proceeding to step S3; otherwise, staying at step S2 to continue detecting current time and determining whether the P-th reminder time T_{P} is reached;

S3: sending the P-th reminder content information while detecting a response message within a first predetermined sending time; if a response message is received within the first predetermined sending time, proceeding to step S4; if no response message is received within the first predetermined sending time, stopping sending the P-th reminder content information and modifying the P-th reminder time T_{P}, wherein one of modifying way includes: no longer determining whether the current time reaches the P-th reminder time T_{P} before 24:00 on that day; and

S4: determining whether the response message is a first response message or a second response message; if it is the first response message, stopping sending the P-th reminder content information and cancelling the P-th reminder message; if it is the second response message, stopping sending the P-th reminder content information and changing the P-th reminder time T_{P} to a delayed time T′_{P}.

Specifically, step S2 further includes: if the P-th reminder time is not reached and no second response message is detected, continuing to detect current time; if the P-th reminder time is not reached but the second response message is detected, changing the P-th reminder time T_{P} to the delayed time T′_{P}.

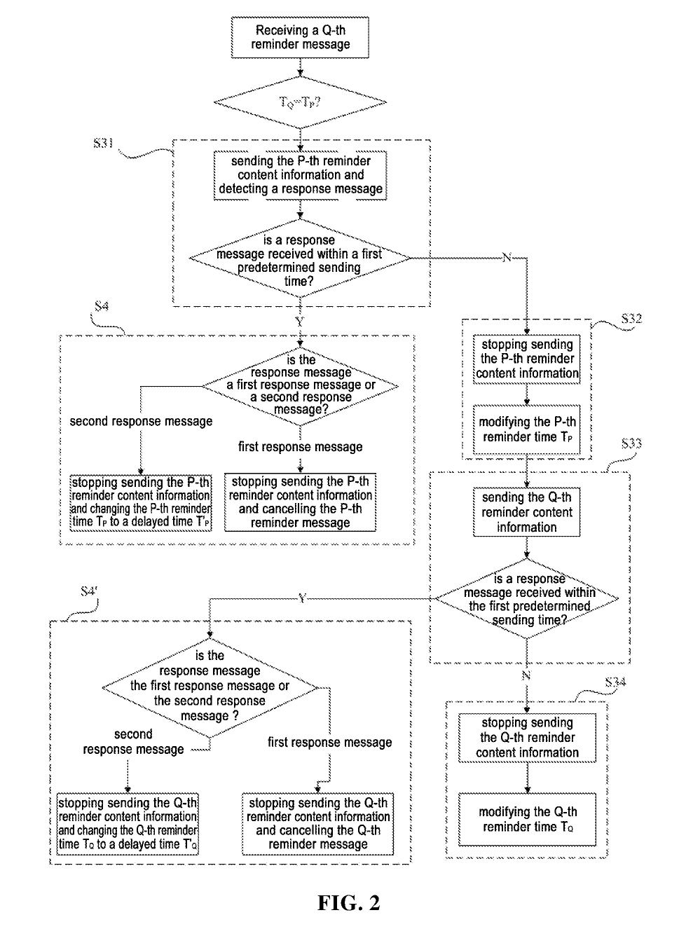

FIG. 2 is a flowchart of a message reminding method in a second embodiment of the present invention. As shown in FIG. 2, the method further includes receiving a Q-th reminder message, which includes a Q-th reminder time T_{Q} and a Q-th reminder content information, where Q is a natural number, Q≠P and T_{Q}>T_{P}.

Specifically, when T′_{P}=T_{Q}, step S3 further includes:

step S31: sending the P-th reminder content information while detecting a response message within the first predetermined sending time: if a response message is received within the first predetermined sending time, proceeding to step S4; if no response message is received within the first predetermined sending time, proceeding to steps S32 and S33;

step S32: stopping sending the P-th reminder content information, and modifying the P-th reminder time T_{P} to increase the P-th reminder time T_{P} by 24 hours;

step S33: sending the Q-th reminder content information while detecting a response message within the first predetermined sending time: if a response message is received within the first predetermined sending time, proceeding to step S4′; if no response message is received within the first predetermined sending time, proceeding to step 34;

step S34: stopping sending the Q-th reminder content information and modifying the Q-th reminder time T_{Q} to increase the Q-th reminder time T_{Q} by 24 hours.

Step S4′ includes: determining whether the response message is the first response message or the second response message: if it is the first response message, stopping sending the Q-th reminder content information and cancelling the Q-th reminder message; if it is the second response message, stopping sending the Q-th reminder content information and changing the Q-th reminder time T_{Q} to a delayed time T′_{Q}.

Step S4 includes: determining whether the response message is a first response message or a second response message: if it is the first response message, stopping sending the P-th reminder content information and cancelling the P-th reminder message; if it is the second response message, stopping sending the P-th reminder content information and changing the P-th reminder time T_{P} to a delayed time T′_{P}.

The method further includes: when the detected current time is 23:59, sending reminder content information of to-be-reminded messages in order of reminder times of the to-be-reminded messages while detecting a response message within a second predetermined sending time;

determining whether or not the response message is the first or second response message: if it is the first or second response message, stopping sending the reminder content information of the to-be-reminded messages; and

cancelling all of the to-be-reminded messages, the to-be-reminded messages referring to reminder messages, for which, whether respective reminder times are reached is still to be determined.

Specifically, the method includes setting at least one of an indication light of a different color, a prompt voice and a vibration mode according to each of the reminder messages; and sending the P-th reminder content information further includes: after receiving the P-th reminder content information, performing message reminding process in at least one of the following ways of: sending out a prompt voice corresponding to the P-th reminder message, lighting or blinking an indication light corresponding to the P-th reminder message, displaying content corresponding to the P-th reminder message on a display screen, and vibrating a vibration motor in a vibration mode corresponding to the P-th reminder message.

Specifically, step S3 further includes: if no response message is received within the first predetermined sending time, further transmitting the P-th reminder time T_{P} and the P-th reminder content information, so that a receiver can remind the P-th reminder time T_{P} and the P-th reminder content information. Specifically, the transmission is performed wirelessly, and the receiver reminds the information sender of the P-th reminder time T_{P} and the P-th reminder content information.

Specifically, the message reminding method of the present invention is applicable to an intelligent mobile terminal and/or a wearable device. Alternatively, it is applicable to a device that is independent from, but can be integrated with, a smartphone, a wearable device, or a combination thereof.

Specifically, the N reminder messages are N medication reminder messages wherein a P-th medication reminder message includes a P-th reminder time T_{P} indicating medication time, and a P-th reminder content information indicating medicine type.

Thereinafter, the message reminding method of the present invention is described in detail by applying the method into two different circumstances.

### First Application Embodiment: Meeting Agenda Memorandum

Firstly, for example, two meeting agenda that needs to be reminded, namely, a first meeting reminder and a second meeting reminder, are inputted into a smartphone through speech or keyboard (memorandum records may be directly imported from a document with a compatible format such as WORD, TXT, etc.). Each reminder record may serve as one reminder message, and correspondingly, each reminder message has a reminder time T1 or T2 and a first or second meeting reminder content, and the meeting reminder content may include name and location of the agenda, material(s) to be carried, note(s), and other information. Here, the time T1 or T2 includes time elements like year, month, day, hour, minute and second. The number of the reminder messages is a natural number larger than or equal to 1, and specifically, is only limited by storage space of the phone.

The reminder messages can form one to-be-reminded message list in both the storage space of the phone and on the display screen of the phone.

When adding the reminder messages, the message list is sequentially displayed on the display screen of the phone. Such display is intuitive and can make a user/reminded person apprehend at a glance. Furthermore, during the display, if any one or a combination of a display mode using different color bars, a display mode using different patterns, a display mode using rectangles having different sizes, and a display mode with a hiding function is adopted for display, technical effect of more friendly human-computer interaction can be achieved.

For example, the first meeting reminder is displayed in red, and the second meeting reminder is displayed in yellow. Then, the smartphone determines whether or not the current time reaches the reminder time T1 or T2. This determination may be implemented by means of an interrupt or clock polling.

When the reminder time of a certain reminder message is reached, for example, T1 is reached, the red bar, the pattern, or the like, corresponding to the message is dynamically displayed (e.g., by way of blinking) on the screen of the phone, and/or is displayed with an animation effect (e.g., zooming), to remind the user to attend the first meeting. Alternatively, a red indication light corresponding to the message on a wearable device blinks to remind the user to attend the first meeting.

Duration of the above dynamic effect is a preset time period, for example, 2 minutes. During this time period, if the user presses a button on the keyboard or touch screen for a short time, clicks on a specific position on the screen of the phone, makes a specific gesture, or makes a specific sound, the phone will stop the display of the above dynamic effect, and determine that the user has confirmed acknowledgement of the reminder message. Alternatively, by pressing an operation button on the wearable device for a short time, it is confirmed that the reminder message is acknowledged, that is, the purpose of the first meeting reminder message has been achieved. At this point, the message is deleted from the to-be-reminded message list. However, the deletion of the message may not be permanent. For example, the user may restore the deleted message back to the reminder list from a storage space where the deleted reminder message is stored.

If during the above two minutes, it is inconvenient for the user to view the reminder message, or the user is in the middle of other transaction(s) and thus has no time to take care of the reminder message, or the user wants to change the reminder time of the current reminder message for the reason of a change in objective circumstances or other reasons, the user can stop the phone from displaying the above dynamic effect, by pressing a button on the keyboard or touch screen for a long time, clicking on a specific position on the screen of the phone, making a specific gesture, or making a specific sound, or the user can stop the reminder by pressing an operation button on the wearable device for a long time, and two options are offered to the user. As a first option, the message will be reminded again after a delay of half an hour by default, and as a second option, a new reminder time T3 is set by the user. Then, when the new reminder time T3 is reached, the first meeting reminder message will be reminded again with the above dynamic effect.

If the user gives no response in any predetermined way during the above two minutes, the response including, for example, pressing an operation button on the wearable device, pressing a button on the keyboard, clicking on a specific position on the screen of the phone, making a specific gesture, or making a specific sound, it is indicated that the user wants to ignore the message reminder. Therefore, the first meeting reminder message which was reminded just now will be deleted or cancelled once the two minutes elapses.

If the reminder time of the earliest (or the nearest) to-be-reminded message (e.g., the second meeting reminder message) is not reached yet, and the phone or the wearable device receives a response message such as pressing a button on the keyboard or touch screen for a long time, clicking on a specific position on the screen of the phone, making a specific gesture, making a specific sound, or the like, the reminder time of the second meeting reminder message is delayed.

According to a variation of the present embodiment, the message that was reminded just now will be reminded again at a time set by the user. For example, the user attends a regular meeting at 9:00 AM every Monday. At 8:30 AM on a certain Monday, the smartphone again reminds the user of the regular meeting. However, the user happens to be on a business trip at that time, and cannot attend the meeting, but he/she does not want to delete or cancel the reminder message (because he/she is likely to attend the regular meeting next week as usual). Therefore, ignoring the message reminder may be set, by the user, to delay the reminder time of the message by one week and still keep the message in the to-be-reminded message list.

Criteria for the above long time and short time for pressing a button/key or touch screen may be set by the user, for example, three seconds may be taken as a dividing line. Continuous pressing for less than three seconds is considered to be short-time pressing on a key or a touch screen, and release of the key means the end of the current pressing operation. Continuous pressing for three seconds or more is considered to be long-time pressing on the key or the touch screen, and release of the key means the end of the current pressing operation.

The above keyboard may be a physical keyboard, or a virtual keyboard displayed on the screen of the phone.

In the present embodiment, if a case where reminder times of two reminder messages are the same occurs when the phone reminds a certain message, for example, T1 and T2 arrive at the same time, then the operation is performed in the following ways.

In a first case where both of the reminder times of the two messages have never been changed or delayed, the two messages are reminded in the order in which they were inputted into the to-be-reminded message list.

In a second case where one of the reminder times of the two messages has been changed or delayed, and for example, T3 and T2 arrive at the same time, the message whose reminder time T3 has been changed or delayed is reminded first, and then the message having the reminder time T2 is reminded.

In a third case where both of the reminder times of the two messages have been changed or delayed, the two messages are reminded in the order in which they enter into the to-be-reminded message list.

During the process of sequentially reminding the two messages, reminding process of each message is exactly the same as the foregoing reminding process of the reminder message.

According to a variation of the present embodiment, there may be an interval of a predetermined time (e.g., 2 seconds) between the sequential processes of reminding the two messages

The above three cases are described by taking two messages as an example. When the number of messages in these cases is larger than 2, the messages are processed in a same way.

Before the midnight (24:00) of each day, all of the to-be-reminded messages are reminded for the last time on that day at the beginning of the last one minute (23:59) in the following way: firstly, all of the to-be-reminded messages are reminded in sequence of the messages in the to-be-reminded message list (also in consideration of the above-described special cases), for example, the indication lights corresponding to the messages blink circularly for one minute, and in the meanwhile the motor vibrates; then, all of the to-be-reminded messages are cancelled. From the beginning of 23:59, current reminder(s) can be canceled by key pressing (long-time or short-time pressing on key or touch screen, or the like) once such reminding operation occurs. The to-be-reminded messages refer to the reminder messages, for which, whether respective reminder times are reached still are to be determined.

In the present embodiment, the above reminders may be presented by means of at least one of sound, light, vibration, screen display, and the like.

According to a variation of the present embodiment, for the reminder message for which no response or feedback is received from the user during the reminding process, message contents corresponding to the message such as agenda time, meeting location, meeting notes, status of acknowledge or delay of reminder receipt will be transmitted to a relative's phone or a friend's phone, or to a preset colleague's phone. The transmission may be performed by at least one of communication methods such as SMS, WeChat, QQ, mail, and the like. Then, the user is reminded by other person to pay attention to the ignored reminder message.

In addition, the method in the embodiment can not only be applied to smartphones, but can also be applied to other intelligent products including dumbphones, touch-free push-button phones, tablet computers, GOOGLE GLASS and wristbands, and wearable intelligent devices, such as pedometers, calorie calculators, iWatch, Baidu bikes, etc.

The message reminding method of an intelligent device provided by the present invention is applicable to a sequential reminder condition where multiple tasks need to be finished at multiple times. The method is described in detail below by taking a case in which a user is reminded to take medicines as an example.

### Second Application Embodiment: Medication Reminder

Firstly, for example, five medication messages that need to be reminded, namely, a first medication reminder, a second medication reminder, a third medication reminder, a fourth medication reminder and a fifth medication reminder, are inputted into a smartphone through speech or keyboard (memorandum records may be directly imported from a document with a compatible format such as WORD, TXT, etc.). Correspondingly, each reminder message has a reminder time T1, T2, T3, T4 or T5 and a first, second, third, fourth or fifth medication reminder content, and the medication reminder content may include medicine name, medicine type, medication quantity, notes and other information. Here, the time T1, T2, T3, T4 or T5 includes time elements like year, month, day, hour, minute and second. The number of the reminder messages is a natural number larger than or equal to 1, and specifically, is only limited by storage space of the phone.

The reminder messages can form one to-be-reminded message list in both the storage space of the phone and on the display screen of the phone.

When adding the reminder messages, the message list is sequentially displayed on the display screen of the phone. Such display is intuitive and can make a user/reminded person apprehend at a glance. Furthermore, during the display, if any one or a combination of a display mode using different color bars, a display mode using different patterns, a display mode using rectangles having different sizes, and a display mode with a hiding function is adopted for display, technical effect of more friendly human-computer interaction can be achieved.

In the embodiment, it is assumed that the first to fifth medication reminders are respectively indicated by red, yellow, green, purple and blue indication light patterns, and the medication quantity is indicated by the blinking number of the corresponding indication light. For example, if the red indication light blinks for three times, it is indicated that the content of the first medication reminder is to take three tablets of medicine corresponding to the red light.

Then, the smartphone determines whether the current time point reaches one of the five reminder times. This determination may be implemented by means of an interrupt or clock polling.

When the reminder time of a certain reminder message is reached, for example, T1 is reached, the color bar, the pattern, or the like, corresponding to the message is dynamically displayed (e.g., by way of blinking) on the screen of the phone, and/or is displayed with an animation effect (e.g., zooming), to remind the user to take a certain medicine. Alternatively, the red indication light corresponding to the first medication reminder on a wearable device blinks for three times to remind the user to take three tablets of the medicine corresponding to the first medication reminder.

Duration of the above dynamic effect is a preset time period, for example, 2 minutes. During this time period, if the user presses a button on the keyboard or touch screen for a short time, clicks on a specific position on the screen of the phone, makes a specific gesture, or makes a specific sound, the phone will stop the display of the above dynamic effect, and determines that the user has confirmed acknowledgement of the reminder message. Alternatively, by pressing an operation button on the wearable device for a short time, it can be confirmed that the medicine has been taken according to the reminder, that is, the purpose of this reminder message has been achieved. At this point, the message is deleted from the to-be-reminded message list. However, the deletion of the message may not be permanent. For example, the user may restore the canceled message back to the reminder list from a storage space where the canceled reminder message is stored.

If during the above two minutes, it is inconvenient for the user to view the reminder message, or the user is in the middle of other transaction(s) and thus has no time to take care of the reminder message, or the user wants to change the reminder time of the current reminder message for the reason of a change in objective circumstances or other reasons, the user can stop the phone from displaying the above dynamic effect, by pressing a button on the keyboard or touch screen for a long time, clicking on a specific position on the screen of the phone, making a specific gesture, or making a specific sound, or the user can stop the reminder by pressing an operation button on the wearable device for a long time, and two options are offered to the user. As a first option, the message will be reminded again after a delay of half an hour by default, and as a second optional, a new reminder time T3 is set by the user. Then, when the new reminder time T3 is reached, the first medication reminder message will be reminded again with the above dynamic effect. According to a variation of the embodiment, when pressing a button on the keyboard or touch screen for a long time, clicking on a specific position on the screen of the phone, making a specific gesture, or making a specific sound, the five indication lights for medication blink for two times together.

If the user gives no response in any predetermined way during the above two minutes, the response including, for example, pressing an operation button on the wearable device, pressing a button on the keyboard, clicking on a specific position on the screen of the phone, making a specific gesture, or making a specific sound, it is indicated that the user wants to ignore the message reminder. Therefore, the first medication reminder message which was reminded just now will be deleted or cancelled once the two minutes elapses.

If the reminder time of the earliest (or nearest) to-be-reminded message is not reached yet, for example, the message is the fourth medication reminder message, and the phone or the wearable device receives a response message such as pressing a button on the keyboard or touch screen for a long time, clicking on a specific position on the screen of the phone, making a specific gesture, making a specific sound, or the like, the reminder time of the fourth medication reminder message is delayed.

According to a variation of the present embodiment, the message that was reminded just now will be reminded again at the time set by the user. For example, the user takes a tonic drug at 8:30 AM every day. During a certain time period, the user happens to catch a cold and a fever, and is taking a cold medicine and an anti-inflammatory drug. The user of the smartphone does not want to delete or cancel the reminder message (because he/she is likely to recover from the cold together and can take the tonic drug tomorrow as usual). Therefore, ignoring the message reminder may be set, by the use, to delay the reminder time of the message by one day (increase the reminder time by 24 hours) and still keep the message in the to-be-reminded message list.

Criteria for the above long time and short time for pressing a button/key or touch screen may be set by the user, for example, three seconds may be taken as a dividing line. Continuous pressing for less than three seconds is considered to be short-time pressing on a key or a touch screen, and release of the key means the end of the current pressing operation. Continuous pressing for three seconds or more is considered to be long-time pressing on the key or the touch screen, and release of the key means the end of the current pressing operation.

The keyboard may be a physical keyboard, or a virtual keyboard displayed on the screen of the phone.

In the present embodiment, if a case where reminder times of two reminder messages are the same occurs when the phone reminds a certain message, the operation is performed in the following ways.

In a first case where both of the reminder times of the two messages have never been changed or delayed, the two messages are reminded in the order in which they were inputted into the to-be-reminded message list.

In a second case where one of the reminder times of the two messages has been changed or delayed, the message whose reminder time has been changed or delayed is reminded first, and then the other message is reminded.

In a third case where both of the reminder times of the two messages have been changed or delayed, the two messages are reminded in the order in which they enter into the to-be-reminded message list.

For example, the first medication reminder message is delayed to 13:01, the second medication reminder message is originally scheduled to be reminded at 13:00, and a reminding time length for the mediation reminder message is 2 minutes, therefore, at 13:00, the first medication reminder message is firstly reminded, and no matter which operation is performed by the user on the first medication reminder message, the end of the operation is taken as an end mark, from which the second medication reminder message is reminded after ten seconds.

During the process of sequentially reminding the two messages, reminding process of each message is exactly the same as the foregoing reminding process of the reminder message.

According to a variation of the present embodiment, there may be an interval of a predetermined time (e.g., 2 seconds) between the sequential processes of reminding the two messages

The above three cases are described by taking two messages as an example. When the number of messages in these cases is larger than 2, the messages are processed in a same way.

Before the midnight (24:00) of each day, all of the to-be-reminded messages are reminded for the last time on that day at the beginning of the last one minute (23:59) in the following way: firstly, all of the to-be-reminded messages are reminded in sequence of the messages in the to-be-reminded message list (also in consideration of the above-described special cases), for example, the indication lights corresponding to the messages blink circularly for one minute, and in the meanwhile the motor vibrates; then, all of the to-be-reminded messages are cancelled. From the beginning of 23:59, current reminder(s) can be canceled by key pressing (long-time or short-time pressing on key or touch screen, or the like) once such reminding operation occurs. The to-be-reminded messages refer to the reminder messages, for which, whether respective reminder times are reached are still to be determined.

In the present embodiment, the above reminders may be presented by means of at least one of sound, light, vibration, screen display, and the like.

According to a variation of the present embodiment, for the reminder message for which no response or feedback is received from the user during the reminding process, message contents corresponding to the message such as medication time, medicine type, medicine name, notes, status of confirmation or delay of medication will be transmitted to a relative's phone or a friend's phone, or to a preset colleague's phone. The transmission may be performed by at least one of communication methods such as SMS, WeChat, QQ, mail, and the like. Then, the user is reminded by other person to pay attention to the ignored reminder message. In this way, by providing two or more intelligent terminals and transmitting the reminder information contents to the multiple terminals wirelessly, the role of multiple supervisions and reminders can be played, thus achieving the purpose of remote reminder, wardship and care.

In addition, the method of the present embodiment can not only be applied to smartphones, but can also be applied to other intelligent products including dumbphones, touch-free push-button phones, tablet computers, GOOGLE GLASS and wristbands, and wearable intelligent devices, such as pedometers, calorie calculators, iWatch, Baidu bikes, etc.

The method may also be used to, for example, remind staff to finish different work tasks at different times, or remind students to finish different assignments at different times, which are not listed one by one herein.

The reminding method provided by the present invention can set relevant parameters (e.g., reminder time, reminder content, etc.) freely, conveniently and flexibly, and help the user to accurately finish reminders on time and quantity. Furthermore, after the reminder is sent out, the user can give a feedback on confirmation or delay of completion of the reminder according to his/her own situation, the system can proceed accordingly upon receipt of the feedback, thus a human-computer interaction function can be achieved, and management of the reminder messages is more efficient and humanized. By providing two or more intelligent terminals and transmitting the reminder information contents to the multiple terminals wirelessly, the role of multiple supervisions and reminders can be played, thus achieving the purpose of remote reminder, wardship and care.

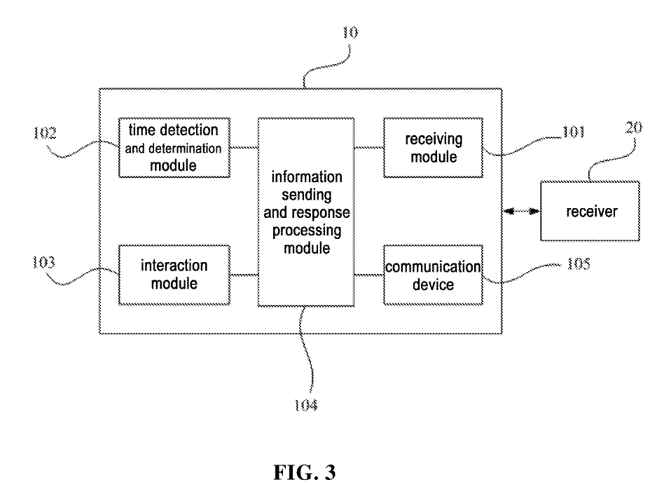

FIG. 3 is a structural block diagram of a message reminding device provided by the present invention.

The message reminding device 10 of the present invention includes a receiving module 101, a time detection and determination module 102, an interaction module 103, an information sending and response processing module 104. The receiving module 101 is configured to receive N reminder messages, wherein a P-th reminder message includes a P-th reminder time T_{P} and a P-th reminder content information, where N and P are natural numbers, and P≦N. The time detection and determination module 102 is configured to detect current time and determine whether the current time reaches the P-th reminder time T_{P}. The interaction module 103 is configured to perform, after receiving the P-th reminder content information, message reminding process in at least one of the following ways of: sending out a prompt voice corresponding to the P-th reminder message, lighting or blinking an indication light corresponding to the P-th reminder message, displaying content corresponding to the P-th reminder message on a display screen, and vibrating a vibration motor in a vibration mode corresponding to the P-th reminder message. The information sending and response processing module 104 is configured to send the P-th reminder content information to the interaction module 13 while detecting a response message within a first predetermined sending time: if the response message is received within the first predetermined sending time, determine whether the response message received by the information sending and response processing module 104 is a first response message or a second response message, if it is the first response message, stop sending the P-th reminder content information and cancel the P-th reminder message, and if it is the second response message, change the P-th reminder time T_{P} to a delayed time T′_{P}; if no response message is received within the first predetermined sending time, stop sending the P-th reminder content information to the interaction module 103 and modify the P-th reminder time T_{P}, wherein one of modifying ways includes: making the time detection and determination module 102 no longer determine whether the current time reaches the P-th reminder time T_{P} before 24:00 on that day.

Further, the time detection and determination module 102 is further configured to continue to detect current time if the P-th reminder time T_{P} is not reached and no second response message is detected, and change the P-th reminder time T_{P} to the delayed time T′_{P} if the P-th reminder time T_{P} is not reached but the second response message is detected,

Further, the receiving module 101 is configured to receive a Q-th reminder message, which includes a Q-th reminder time T_{Q} and a Q-th reminder content information, where Q is a natural number, Q≠P and T_{Q}>T_{P}; and the information sending and response processing module 104 is, when T′_{P}=T_{Q}, sequentially configured to:

send the P-th reminder content information to the interaction module 103 while detecting a response message: if the response message is received within the first predetermined sending time, determine whether the response message received by the information sending and response processing module is a first response message or a second response message, if it is the first response message, stop sending the P-th reminder content information and cancel the P-th reminder message, if it is the second response message, change the P-th reminder time T′_{P} to a delayed time T″_{P}; if no response message is received within the first predetermined sending time, stop sending the P-th reminder content information to the interaction module 103 and modify the P-th reminder time T_{P}, wherein one of modifying ways includes: making the time detection and determination module 102 no longer determine whether the current time reaches the P-th reminder time T_{P} before 24:00 on that day; and

send the Q-th reminder content information to the interaction module 103 while detecting a response message: if the response message is received within the first predetermined sending time, determine whether the response message received by the information sending and response processing module 104 is the first response message or the second response message, if it is the first response message, stop sending the Q-th reminder content information and cancel the Q-th reminder message, if it is the second response message, change the Q-th reminder time T_{Q} to a delayed time T′_{Q}; if no response message is received within the first predetermined sending time, stop sending the Q-th reminder content information to the interaction module 103 and modify the Q-th reminder time T_{Q}, wherein one of modifying ways includes: making the time detection and determination module 102 no longer determine whether the current time reaches the Q-th reminder time T_{Q} before 24:00 on that day.

Further, the information sending and response processing module 104 is further configured to send reminder content information of all to-be-reminded messages in order of reminder times of the to-be-reminded messages while detecting a response message within a second predetermined sending time; and determine whether or not the response message is the first or second response message, if it is the first or second response message, stop sending the reminder content information of the to-be-reminded messages; and the time detection and determination module 102 is further configured to cancel all of the to-be-reminded messages when the detected current time is 23:59, the to-be-reminded messages referring to the reminder messages, for which, whether respective reminder times are reached is still to be determined.

Specifically, the interaction module 103 includes at least one of an indication light, a loudspeaker, a display screen, and a vibration motor, and accordingly, set at least one of indication lights of different colors, prompt voices, display contents, and vibration modes according to the reminder messages.

Further, the message reminding device of the present invention further includes a communication device 105, which is configured to transmit, if no response message is received within the first predetermined sending time, the P-th reminder time T_{P} and the P-th reminder content information to a receiver 20, so that the receiver 20 can remind the information sender (the message reminding device 10) of the P-th reminder time T_{P} and the P-th reminder content information, wherein, the transmission is performed wirelessly. The receiver 20 reminds the information sender of the P-th reminder time T_{P} and the P-th reminder content information after receiving the P-th reminder time T_{P} and the P-th reminder content information through wireless communication. In this way, by providing two or more intelligent terminals and transmitting the reminder information contents to the multiple terminals wirelessly, the role of multiple supervisions and reminders can be played, thus achieving the purpose of remote reminder, wardship and care.

Specifically, the message reminding device of the present invention is integrated in an intelligent mobile terminal and/or a wearable device. A connection may be established between the wearable device and the intelligent mobile terminal by an application (APP).

Specifically, the N reminder messages are N medication reminder messages, wherein a P-th medication reminder message includes a P-th reminder time T_{P} indicating medication time, and a P-th reminder content information indicating medicine type.

The message reminding device provided by the present invention can set relevant parameters (e.g., reminder time, reminder content, etc.) freely, conveniently and flexibly, and help the user to accurately finish reminders on time and quantity. Furthermore, after the reminder is sent out, the user can give a feedback on confirmation or delay of completion of the reminder according to his/her own situation, the system can proceed accordingly upon receipt of the feedback, thus a human-computer interaction function can be achieved, and management of the reminder messages is more efficient and humanized. By providing two or more intelligent terminals and transmitting the reminder information contents to the multiple terminals wirelessly, the role of multiple supervisions and reminders can be played, thus achieving the purpose of remote reminder, wardship and care.

As a variation of the present invention, the message reminding method and the message reminding device may be completely based on a device which is designed and manufactured separately. Specifically, the message reminding device of the present invention includes a receiving module, a time detection and determination module, an interaction module, an information sending and response processing module. The receiving module is configured to receive N reminder messages, wherein a P-th reminder message includes a P-th reminder time T_{P} and a P-th reminder content information, where N and P are natural numbers, and P≦N. The time detection and determination module is configured to detect current time and determine whether the current time reaches the P-th reminder time T_{P}. The interaction module is configured to perform, after receiving the P-th reminder content information, message reminding process in at least one of the following ways of: sending out a prompt voice corresponding to the P-th reminder message, lighting or blinking an indication light corresponding to the P-th reminder message, displaying a content corresponding to the P-th reminder message on a display screen, and vibrating a vibration motor in a vibration mode corresponding to the P-th reminder message. The information sending and response processing module is configured to send the P-th reminder content information to the interaction module while detecting a response message within a first predetermined sending time: if the response message is received within the first predetermined sending time, determine whether the response message received by the information sending and response processing module is a first response message or a second response message, if it is the first response message, stop sending the P-th reminder content information and cancel the P-th reminder message, and if it is the second response message, change the P-th reminder time T_{P} to a delayed time T′_{P}; if no response message is received within the first predetermined sending time, stop sending the P-th reminder content information to the interaction module and modify the P-th reminder time T_{P}, wherein one of modifying ways includes: making the time detection and determination module no longer determine whether the current time reaches the P-th reminder time T_{P} before 24:00 on that day.

Further, the time detection and determination module is further configured to continue to detect current time if the P-th reminder time is not reached and no second response message is detected, and change the P-th reminder time T_{P} to the delayed time T′_{P} if the P-th reminder time is not reached but the second response message is detected,

Further, the receiving module is further configured to receive a Q-th reminder message, which includes a Q-th reminder time T_{Q} and a Q-th reminder content information, where Q is a natural number, Q≠P and T_{Q}>T_{P}; and the information sending and response processing module is, when T′_{P}=T_{Q}, sequentially configured to:

send the P-th reminder content information to the interaction module while detecting a response message: if the response message is received within the first predetermined sending time, determine whether the response message received by the information sending and response processing module is a first response message or a second response message, if it is the first response message, stop sending the P-th reminder content information and cancel the P-th reminder message, and if it is the second response message, change the P-th reminder time T′_{P} to a delayed time T″_{P}; if no response message is received within the first predetermined sending time, stop sending the P-th reminder content information to the interaction module and modify the P-th reminder time T_{P}, wherein one of modifying ways includes: making the time detection and determination module no longer determine whether the current time reaches the P-th reminder time T_{P} before 24:00 on that day; and send the Q-th reminder content information to the interaction module while detecting a response message: if the response message is received within the first predetermined sending time, determine whether the response message received by the information sending and response processing module is the first response message or the second response message, if it is the first response message, stop sending the Q-th reminder content information and cancel the Q-th reminder message, and if it is the second response message, change the Q-th reminder time T_{Q} to a delayed time T′_{Q}; if no response message is received within the first predetermined sending time, stop sending the Q-th reminder content information to the interaction module and modify the Q-th reminder time T_{Q}, wherein one of modifying ways includes: making the time detection and determination module no longer determine whether the current time reaches the Q-th reminder time T_{Q} before 24:00 on that day.

Further, the information sending and response processing module is further configured to send reminder content information of all to-be-reminded messages in order of reminder times of the to-be-reminded messages while detecting a response message within a second predetermined sending time; and determine whether or not the response message is the first or second response message, if it is the first or second response message, stop sending the reminder content information of the to-be-reminded messages; and the time detection and determination module is further configured to cancel all of the to-be-reminded messages when the detected current time is 23:59, the to-be-reminded messages referring to the reminder messages, for which, whether respective reminder times are reached is still to be determined.

Specifically, the interaction module includes at least one of an indication light, a loudspeaker, a display screen, and a vibration motor, and accordingly set at least one of indication lights of different colors, prompt voices, display contents, and vibration modes according to the reminder messages.

Further, the message reminding device of the present invention further includes a communication device, which is configured to transmit out the P-th reminder time T_{P} and the P-th reminder content information if no response message is received within the first predetermined sending time, so that a receiver can remind the information sender (i.e., the message reminding device) of the P-th reminder time T_{P} and the P-th reminder content information. The transmission is performed wirelessly. The receiver reminds the information sender of the P-th reminder time T_{P} and the P-th reminder content information after receiving the P-th reminder time T_{P} and the P-th reminder content information through wireless communication. In this way, by including two or more intelligent terminals and transmitting the reminder information contents to the multiple terminals wirelessly, the role of multiple supervisions and reminders can be played, thus achieving the purpose of remote reminder, wardship and care.

Specifically, the receiver is an intelligent mobile terminal or a wearable device, or a combination thereof. A connection may be established between the message reminding device and the receiver by an application (APP).

Specifically, the N reminder messages are N medication reminder messages, wherein a P-th medication reminder message includes a P-th reminder time T_{P} indicating medication time, and a P-th reminder content information indicating medicine type.

The message reminding device of the present invention is based on a device that is separately designed and manufactured, does not need to be integrated in or attached to an intelligent device or a wearable device or a combination thereof, but may be combined with or attached to a smartphone, a wearable device, or a combination thereof by wired or wireless communication. Integration and portability are improved while realizing humanized reminders, thereby bringing users a more comprehensive and convenient reminder service.

It could be understood that the above implementations are only exemplary implementations for illustrating the principle of the present invention, but the present invention is not limited thereto. Various variations and improvements can be made by those skilled in the art without departing from the spirit and essence of the present invention, and these variations and improvements shall also fall into the protection scope of the present invention.

1. A message reminding method, comprising the following steps:
(1) receiving N reminder messages; wherein a P-th reminder message comprises a P-th reminder time T_{P} and a P-th reminder content information, where N and P are natural numbers, and P≦N;
(2) detecting current time and determining whether the P-th reminder time T_{P} is reached, if yes, proceeding to step (3); otherwise, continuing to detect current time;
(3) sending the P-th reminder content information while detecting a response message within a first predetermined sending time:
if the response message is received within the first predetermined sending time, proceeding to step (4);
if no response message is received within the first predetermined sending time, stopping sending the P-th reminder content information and modifying the P-th reminder time T_{P}, wherein one of modifying ways comprises: no longer determining whether the current time reaches the P-th reminder time T_{P} before 24:00 on that day; and
(4) determining whether the response message is a first response message or a second response message: if it is the first response message, stopping sending the P-th reminder content information and cancelling the P-th reminder message; if it is the second response message, stopping sending the P-th reminder content information and changing the P-th reminder time T_{P} to a delayed time T′_{P}.

2. The message reminding method according to claim 1, wherein step (2) further comprises: continuing to detect current time if the P-th reminder time is not reached and no second response message is detected; and changing the P-th reminder time T_{P} to the delayed time T′_{P} if the P-th reminder time is not reached but the second response message is detected.

3. The message reminding method according to claim 1, wherein the method further comprises receiving a Q-th reminder message, which comprises a Q-th reminder time T_{Q} and a Q-th reminder content information, where Q is a natural number, Q≠P and T_{Q}>T_{P}; when T′_{P}=T_{Q}, step S(3) further comprises:
firstly, sending the P-th reminder content information while detecting a response message within the first predetermined sending time:
if the response message is received within the first predetermined sending time, proceeding to step (4);
if no response message is received within the first predetermined sending time, stopping sending the P-th reminder content information and modifying the P-th reminder time T_{P} by increasing the P-th reminder time T_{P} by 24 hours; and
then, sending the Q-th reminder content information while detecting a response message within the first predetermined sending time:
if the response message is received within the first predetermined sending time, proceeding to step (4);
if no response message is received within the first predetermined sending time, stopping sending the Q-th reminder content information and modifying the Q-th reminder time T_{Q} by increasing the Q-th reminder time T_{Q} by 24 hours.

4. The message reminding method according to claim 1, wherein the method further comprises:
when the detected current time is 23:59, sending reminder content information of all to-be-reminded messages in order of reminder times of the to-be-reminded messages while detecting a response message within a second predetermined sending time;
determining whether or not the response message is the first or second response message: if it is the first or second response message, stopping sending the reminder content information of the to-be-reminded messages; and
cancelling all of the to-be-reminded messages, wherein for each of the to-be-reminded messages, whether its reminder time is reached is still to be determined.

5. The message reminding method according to claim 1, wherein the method comprises setting at least one of an indication light of a different color, a prompt voice and a vibration mode for each of the reminder messages; and sending the P-th reminder content information further comprises: after receiving the P-th reminder content information, performing message reminding process in at least one of the following ways of: sending out a prompt voice corresponding to the P-th reminder message, lighting or blinking an indication light corresponding to the P-th reminder message, displaying a content corresponding to the P-th reminder message on a display screen, and vibrating a vibration motor in a vibration mode corresponding to the P-th reminder message.

6. The message reminding method according to claim 1, wherein step (3) further comprises: if no response message is received within the first predetermined sending time, further transmitting out the P-th reminder time T_{P} and the P-th reminder content information, so that a receiver is able to remind the P-th reminder time T_{P} and the P-th reminder content information.

7. The message reminding method according to claim 6, wherein the transmission is performed through wireless communication, and the receiver reminds an information sender of the P-th reminder time T_{P} and the P-th reminder content information.

8. The message reminding method according to claim 1, wherein the method is applied to an intelligent mobile terminal and/or a wearable device.

9. The message reminding method according to claim 1, wherein the N reminder messages are N medication reminder messages, and wherein a P-th medication reminder message comprises a P-th reminder time T_{P} indicating medication time and a P-th reminder content information indicating medicine type or name.

10. A message reminding device, comprising:
a receiving module, configured to receive N reminder messages, wherein a P-th reminder message comprises a P-th reminder time T_{P} and a P-th reminder content information, where N and P are natural numbers, and P≦N;
a time detection and determination module, configured to detect current time and determine whether the current time reaches the P-th reminder time T_{P};
an interaction module, configured to perform, after receiving the P-th reminder content information, message reminding process in at least one of the following ways of: sending out a prompt voice corresponding to the P-th reminder message, lighting or blinking an indication light corresponding to the P-th reminder message, displaying a content corresponding to the P-th reminder message on a display screen, and vibrating a vibration motor in a vibration mode corresponding to the P-th reminder message; and
an information sending and response processing module, configured to send the P-th reminder content information to the interaction module while detecting a response message within a first predetermined sending time:
if the response message is received within the first predetermined sending time, determine whether the response message received by the information sending and response processing module is a first response message or a second response message: if it is the first response message, stop sending the P-th reminder content information and cancel the P-th reminder message; if it is the second response message, change the P-th reminder time T_{P} to a delayed time T′_{P};
if no response message is received within the first predetermined sending time, stop sending the P-th reminder content information to the interaction module and modify the P-th reminder time T_{P}, wherein one of modifying ways comprises: making the time detection and determination module no longer determine whether the current time reaches the P-th reminder time T_{P} before 24:00 on that day.

11. The message reminding device according to claim 10, wherein the time detection and determination module is further configured to: continue to detect current time if the P-th reminder time T_{P} is not reached and no second response message is detected, and change the P-th reminder time T_{P} to the delayed time T′_{P} if the P-th reminder time T_{P} is not reached but the second response message is detected.

12. The message reminding device according to claim 10, wherein the receiving module further receives a Q-th reminder message, which comprises a Q-th reminder time T_{Q} and a Q-th reminder content information, where Q is a natural number, Q≠P and T_{Q}>T_{P}; and
when T′_{P}=T_{Q}, the information sending and response processing module is sequentially configured to:
send the P-th reminder content information to the interaction module while detecting a response message: if the response message is received within the first predetermined sending time, determine whether the response message received by the information sending and response processing module is a first response message or a second response message: if it is the first response message, stop sending the P-th reminder content information and cancel the P-th reminder message; if it is the second response message, change the P-th reminder time T′_{P} to a delayed time T″_{P}; if no response message is received within the first predetermined sending time, stop sending the P-th reminder content information to the interaction module and modify the P-th reminder time T_{P}, wherein one of modifying ways comprises: making the time detection and determination module no longer determine whether the current time reaches the P-th reminder time T_{P} before 24:00 on that day; and
send the Q-th reminder content information to the interaction module while detecting a response message: if the response message is received within the first predetermined sending time, determine whether the response message received by the information sending and response processing module is the first response message or the second response message: if it is the first response message, stop sending the Q-th reminder content information and cancel the Q-th reminder message; if it is the second response message, change the Q-th reminder time T_{Q} to a delayed time T′_{Q}; if no response message is received within the first predetermined sending time, stop sending the Q-th reminder content information to the interaction module and modify the Q-th reminder time T_{Q}, wherein one of modifying ways comprises: making the time detection and determination module no longer determine whether the current time reaches the Q-th reminder time T_{Q} before 24:00 on that day.

13. The message reminding device according to claim 10, wherein the information sending and response processing module is further configured to send reminder content information of all to-be-reminded messages in order of reminder times of the to-be-reminded messages while detecting a response message within a second predetermined sending time; and determine whether or not the response message is the first or second response message: if it is the first or second response message, stop sending the reminder content information of the to-be-reminded messages; and
the time detection and determination module is further configured to cancel all of the to-be-reminded messages when the detected current time is 23:59, wherein for each of the to-be-reminded messages, whether its reminder time is reached is still to be determined.

14. The message reminding device according to claim 10, wherein the interaction module comprises at least one of an indication light, a loudspeaker, a display screen, and a vibration motor, and accordingly sets at least one of an indication light of a different color, a prompt voice, a display content, and a vibration mode for each of the reminder messages.

15. The message reminding device according to claim 10, wherein the message reminding device further comprises:
a communication device, configured to transmit out the P-th reminder time T_{P} and the P-th reminder content information if no response message is received within the first predetermined sending time, so that a receiver is able to remind the P-th reminder time T_{P} and the P-th reminder content information.

16. The message reminding device according to claim 15, wherein the transmission is performed through wireless communication, and the receiver reminds an information sender of the P-th reminder time T_{P} and the P-th reminder content information.

17. The message reminding device according to claim 10, wherein the message reminding device is integrated in an intelligent mobile terminal and/or a wearable device.

18. The message reminding device according to claim 10, wherein the N reminder messages are N medication reminder messages, wherein a P-th medication reminder message comprises a P-th reminder time T_{P} indicating medication time, and a P-th reminder content information indicating medicine name or type.

19. The message reminding method according to claim 2, wherein the method further comprises receiving a Q-th reminder message, which comprises a Q-th reminder time T_{Q} and a Q-th reminder content information, where Q is a natural number, Q≠P and T_{Q}>T_{P}; when T′_{P}=T_{Q}, step S(3) further comprises:
firstly, sending the P-th reminder content information while detecting a response message within the first predetermined sending time:
if the response message is received within the first predetermined sending time, proceeding to step (4);
if no response message is received within the first predetermined sending time, stopping sending the P-th reminder content information and modifying the P-th reminder time T_{P} by increasing the P-th reminder time T_{P} by 24 hours; and
then, sending the Q-th reminder content information while detecting a response message within the first predetermined sending time:
if the response message is received within the first predetermined sending time, proceeding to step (4);
if no response message is received within the first predetermined sending time, stopping sending the Q-th reminder content information and modifying the Q-th reminder time T_{Q} by increasing the Q-th reminder time T_{Q} by 24 hours.

20. The message reminding method according to claim 2, wherein the method further comprises:
when the detected current time is 23:59, sending reminder content information of all to-be-reminded messages in order of reminder times of the to-be-reminded messages while detecting a response message within a second predetermined sending time;
determining whether or not the response message is the first or second response message: if it is the first or second response message, stopping sending the reminder content information of the to-be-reminded messages; and
cancelling all of the to-be-reminded messages, wherein for each of the to-be-reminded messages, whether its reminder time is reached is still to be determined.
